(19) United States
(12) Patent Application Publication
(10) Pub. No.: US 2010/0139008 A1
(43) Pub. Date: Jun. 10, 2010

(54) Ice axe

(76) Inventor: Isaiah Paul Janzen, Sheboygan Falls, WI (US)

Correspondence Address: DAVID PAUL KARASIC, 2 BONNIEVALE DRIVE, BEDFORD, MA, 01730, US

(21) Appl. No.: 12/626,726

(22) Filed: Nov. 27, 2009

Related U.S. Application Data
(60) Provisional application No. 61/120,843, filed on Dec. 8, 2008.

(51) Int. Cl. B26B 23/00; A63B 29/08

(52) U.S. Cl. 7/145; 30/308.3

(57) ABSTRACT

An ice axe for mountaineering with a head that is detachable from the axe's handle. The handle is I-beam shaped in cross-section and joined with the head in a machined, interlocking joint with at least one threaded fastening securing the joint. The axe's head and handle are interchangable to allow increased versatility and usefulness, and the handle's I-beam construction facilitates the handle being driven into snow or ice, while increasing the axe's resistance to applied torsional forces when driven into ice or snow.

### CLAIM OF PRIORITY

This application for patent claims priority from provisional patent application 61120843 filed by the inventor on Dec. 8, 2008.

SOME RELEVANT U.S. PATENTS

| Pat. No. | Title | Filing date |
|---|---|---|
| 5,996,235 | Ice axe | Jan. 29, 1998 |
| 3,719,179 | Ice axes | Oct. 22, 1970 |
| 3,735,434 | Ice axe | Apr. 25, 1972 |
| 4,432,404 | Ice axe | Apr. 02, 1982 |
| 5,425,176 | Handle for ice axe | Feb. 01, 1993 |
| 5,345,635 | Ice axe shovel attachment | Sep. 07, 1993 |
| 5,768,727 | Integrated modular ice axe head | Jan. 19, 1996 |
| 5,937,466 | Lugged ice axe head | Jan. 19, 1996 |
| D130865 | Ice axe | Oct. 11, 2000 |
| D130866 | Ice axe | Oct. 11, 2000 |

### FIELD OF THE INVENTION

This invention relates to tools used in mountaineering in snow and ice. Specifically, the instant invention offers improved ease of penetration of packed snow by the axe's handle compared with a plugged tube handle, as well as improved resistance to the twisting of the axe's head when the handle is buried in snow. Additionally, the joint between the head and the handle creates a more secure connection than in previous designs.

### OBJECTS OF THE INVENTION

1. To provide an ice axe requiring less force to plunge the handle into snow than previous ice axes.

2. To provide an ice axe with fewer parts than previous ice axes.

3. To provide a modular design allowing functionality beyond the preferred embodiment by offering different heads and handle lengths that can be interchanged as appropriate for different applications.

### SUMMARY OF THE INVENTION

Disclosed is an ice axe for use by mountaineers, the handle of which has improved penetration in snow and ice, as well as an improved ability to resist torsional loading when the handle is buried in snow or ice and a twisting moment is applied to the axe head. The axe head is readily detachable from the handle, allowing alternately shaped heads or handles to be fitted.

### DETAILED DESCRIPTION

In mountaineering there are a number of different ways to use an ice axe as an anchor in snow and ice. One of the most common methods of anchoring involves plunging the handle of the ice axe into snow so that when the axe is gripped at the head, or a carabiner is attached to the hole in the head of the axe, there will be resistance to a rotation of the axe which results from a force applied perpendicular to the head. A typical ice axe handle has a tubular cross section and a plugged lower end. This results in a greater cross sectional area which requires more force to plunge into the snow than an I-beam design, as well as offering less resistance to twisting forces. A straight handle further enables plunging with less force than an ice axe with a bent handle because of the larger effective cross section in the plane of the cross section of the bent handle at the spike. A bent handle becomes more appropriate for steep ice and rock climbing by allowing the pick to reach over bulges that a straight handle can not reach over. Additionally, previous designs have a number of parts, including plastic pieces, nuts, rivets, and bolts not required in the present invention. Fewer structural pieces make for fewer points of failure, resulting in a more reliable ice axe.

Ice axes have a pick on the working end used for self arrest and for vertical movement on steep ice. The cross section of the pick is generally a rectangle orientated with the major axis vertical and parallel to the handle of the ice axe and the minor axis perpendicular to the handle of the ice axe and the length of the pick. The shape of that pick is generally shaped in a technical curve or a reverse curve. Technically curved corresponds to a curvature from the chord of a circle with center near the spike of the ice axe. A reverse curve corresponds to a curvature from the chord of a circle with center at some point opposite the spike from the head.

Ice axes generally have an adze or hammer opposite of the pick on the working end of the ice axe. The hammer can be used to pound in pitons and the adze can be used for step or platform cutting as well as digging snow caves. Both are advantageous but applicable in different situations. It is advantageous to mountaineers to have both adze and hammer options. For this reason, one unit with interchangeable heads offer a less expensive and lighter weight alternative to multiple ice axes.

Other embodiments beyond the preferred embodiment are also possible using the same method of joining a working head to a handle. In this way it would be possible to own only one strong sturdy handle and multiple heads, each with its own individual design and purpose beyond that of the preferred embodiment.

### BRIEF DESCRIPTION OF THE DRAWINGS

FIG. 1: Isometric view of axe head

FIG. 2: Left side view of axe head

FIG. 3: Bottom view of axe head

FIG. 4: Rear view of axe head

FIG. 5: Isometric view of handle

FIG. 6: Right side view of handle

FIG. 7: Front view of handle

FIG. 8: Bevel end (bottom) view of handle

### DETAILED DESCRIPTION OF THE DRAWINGS

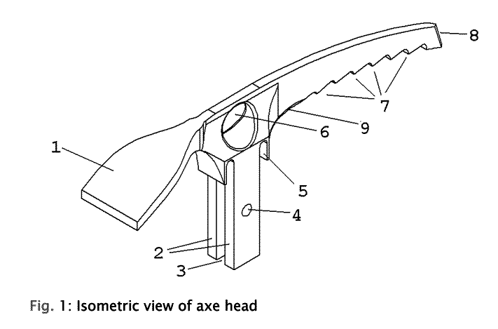

FIG. 1: Isometric view of axe head: 1. Adze, 2. Mounting flanges, 3. Mounting slot, 4. Mounting bolt hole, 5. Flange mounting sockets, 6. Head belay hole, 7. Pick teeth, 8. Pick tip, 9. Stress reducing curve

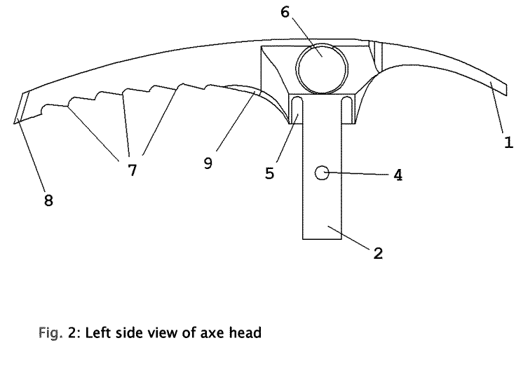

FIG. 2: Left side view of axe head: 1. Adze, 2. Mounting flanges, 4. Mounting bolt hole, 5. Flange mounting sockets, 6. Head belay hole, 7. Pick teeth, 8. Pick tip, 9. Stress reducing curve

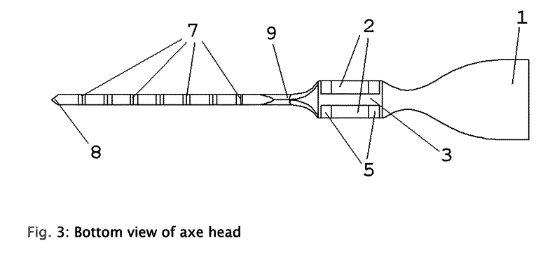

FIG. 3: Bottom view of axe head: 1. Adze, 2. Mounting flanges, 3. Mounting slot, 5. Flange mounting sockets, 7. Pick teeth, 8. Pick tip, 9. Stress reducing curve

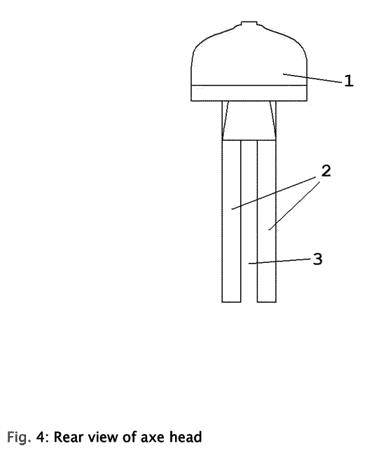

FIG. 4: Rear view of axe head: 1. Adze, 2. Mounting flanges, 3. Mounting slot

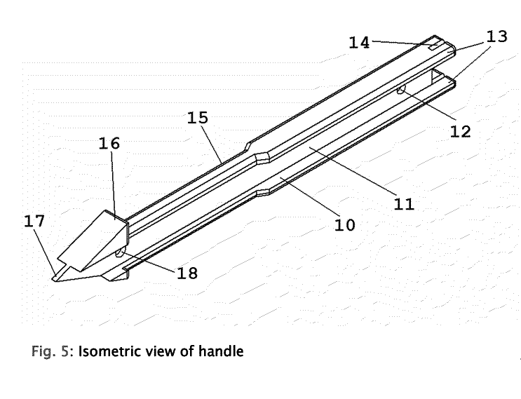

FIG. 5: Isometric view of handle: 10. Handle flange, 11. Handle I-beam webbing, 12. Handle Mounting bolt hole(s), 13. Flange Mountings, 14. Handle mounting slot, 15. Ergonomic hand grip, 16. Pinky rest, 17. Spike 18. Spike leash hole

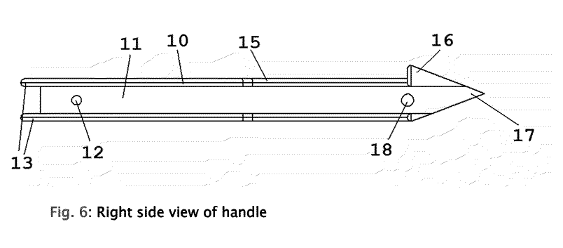

FIG. 6: Right side view of handle: 10. Handle flange, 11. Handle I-beam webbing, 12. Handle Mounting bolt hole, 13. Flange Mountings, 15. Ergonomic hand grip, 16. Pinky rest, 17. Spike 18. Spike leash hole

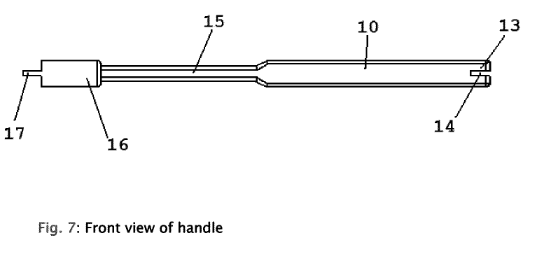

FIG. 7: Front view of handle: 10. Handle flange, 13. Flange Mountings, 14. Handle mounting slot, 15. Ergonomic hand grip, 16. Pinky rest, 17. Spike

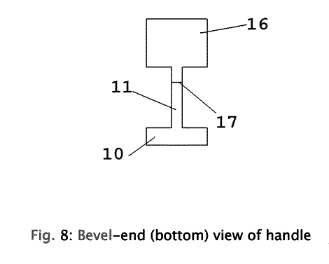

FIG. 8: Bevel end (bottom) view of handle: 10. Handle Flange, 11. Handle I-beam webbing, 16. Pinky rest, 17. Spike

FIG. 1 is an isometric view of the head of the ice axe. The ice axe head consists of the pick and the adz (1) or, optionally, a hammer. The pick is constructed of two circle chords that taper to the front of the axe head. This pick has a plurality of teeth (7) that aid in hooking features like rocks and providing traction to prevent pick from being pulled down and backwards when being used while climbing on snow, ice, or rock. The working end of the pick has a tip (8) that is beveled on both sides and the top to enable it to wedge into ice and snow and provide an anchor for advancement. There is also a stress reducing curve (9) which provides a greater distribution of stress in the head of the ice axe when the pick is being pulled away from the spike [FIG. 5 (17)] on the handle of the ice axe. This area is in tension and a broad curve reduces the stress concentration at this location. There is the head belay hole (6) directly above the mounting flanges (2) which can be used for attachment of a leash or can be used with a carabiner to make an anchor when the handle is inserted vertically into the snow or ice. The ice axe head mounts to the ice axe handle with two mounting flanges (2), with a mounting slot (3) in between, the flanges being placed on either side of the web of the ice axe handle [FIG. 5 (11)]. There is at least one mounting bolt hole (4) in each mounting flange (2) of the ice axe head, a smooth bore hole on one side and a threaded hole on the other. This allows a bolt to be inserted through the mounting flange with the smooth bore hole (4), through the handle mounting bolt hole [FIG. 5 (12)] in the web of the ice axe handle [FIG. 5 (11)] and then threaded into the tapped mounting hole (4) on the opposite mounting flange (2). The four flange mounting sockets (5) are designed to mate with the handle flanges [FIG. 5 (13)] to provide added stability and energy transfer between the ice axe head and the ice axe handle. Each flange mounting socket (5) is designed with a side view consisting of a semicircle at the top of the socket and an open end at the bottom of the socket. The inside face of each flange mounting socket (5) is flat so that it can easily be milled with a flat end mill. The flange mounting sockets (5) are designed so that the handle flanges [FIG. 5 (13)] can be inserted easily and have close tolerances to ensure maximum energy transfer between the ice axe head and the ice axe handle.

FIG. 2 is a left side view of the head of the ice axe.

FIG. 3 is a bottom view of the head of the ice axe.

FIG. 4 is a rear view of the head of the ice axe.

FIG. 5 is an isometric view of the handle of the ice axe. The handle flanges (10) provide torsional and bending resistance in all three dimensions. The handle flanges (10) are connected by the handle I-beam webbing (11). During bending, such as that which would occur when the pick or adze [FIG. 1 (1)] is being driven into snow or ice and produce a moment in the plane of the I-beam webbing (11), the I-beam webbing (11) distributes the force between the two handle flanges (10) so that there is a continuous distribution from compressive forces to tensile forces. Near the top end of the ice axe handle where the handle and head attach is one or more smooth bore mounting bolt hole (12) through which the mounting bolt is inserted when securing the head to the handle. The flange mountings (13) fit into the flange mounting sockets of the head [FIG. 1 (5)]. The shape is designed to be easy to machine with traditional machining methods. This design securely prevents the head and handle from rotating independently of each other regardless of the moment force that is exerted on this joining method. The handle mounting slot (14) allows the flange mountings (13) to function independently of each other allowing greater torsional resistance to rotation about the major axis of the handle as well as torsional resistance about the axis perpendicular to both the major axis of the handle and the axis of any of the holes. This also provides a continuous web of material on the head of the ice axe to run from the stress reducing curve of the head (FIG. 1 (9)] under the pick of the ice axe to the adze [FIG. 1 (1)] which distributes forces further reducing the stress due to applied bending and moments. The ergonomic hand hold (15) is designed to be small enough so that it can be gripped with gloves and mittens while still maintaining some handle flanges (10) so that the grip is not too slender to be comfortable and still providing resistance to bending and torsion. The volume beside the I-beam webbing (11) along the ergonomic hand hold (15) is not filled in so that when the handle is plunged into the snow along the major axis spike (17), the reduced area, compared to a plugged tubular handle, reduces the force required to plunge the handle into hard snow. The optional pinky rest (16) provides support to the little finger when the ice axed is used for self-arrest or for vertical progression used in the traction position. However the pinky rest (16) resists being plunged into the snow along the major axis of the handle spike (17) first compared to a similar ice axe of this I-beam style design without a pinky rest (16). The advantages are situation dependant and two different handles, one with a pinky rest and one without, could be carried for use under the different conditions. Features such as a bent handle may also be appropriate for very steep terrain. The spike (17) provides a point that can be stuck into ice and snow when the ice axe is used in the cane position and provide a third point of balance, in addition to the climber's two legs, to stabilize the mountain climber. The spike leash hole (18) provides a method of attachment for a leash between the ice axe and climber. This would prevent the ice axe from dropping further than the length of the leash should the climber drop it.

FIG. 6 is a right side view of the handle of the ice axe.

FIG. 7 is a front view of the handle of the ice axe.

FIG. 8 is a bevel-end, bottom end, view of the handle of the ice axe.

What is claimed is:

1. An ice axe for mountaineering, comprising a removable axe head and a handle, said axe head and said handle joined together in a machined, interlocking joint with at least one threaded fastening securing the joint.

2. An ice axe as in claim 1 with a handle that is I-beam shaped in cross-section, said handle having a grip such as a pinky rest, or alternately, no grip at all.

3. An ice axe as in claim 2 with a handle that is beveled at the end opposite the axe head.

4. An ice axe as in claim 3 with a removable axe head comprising a pick on one side and an adze on the other side.

5. An ice axe as in claim 3 with a removable axe head comprising a pick on one side and a hammer on the other side.
